(19) United States
(12) Patent Application Publication
(10) Pub. No.: US 2026/0366398 A1
(43) Pub. Date: Nov. 19, 2026

(54) SYSTEMS AND METHODS FOR ACOUSTIC HOLE CLEANING IN DRILLING OPERATIONS

(71) Applicant: SAUDI ARABIAN OIL COMPANY, Dhahran (SA)

(72) Inventors: Murtadha J. AlTammar, Dhahran (SA); Jesus Mierez, Surrey (CA); Rima Taqi Alfaraj, Qatif (SA); Aijaz Ali Shaikh, Dhahran (SA); Chao Liu, Brookshire, TX (US); Khalid Mohammed Alruwaili, Dammam (SA)

(73) Assignees: SAUDI ARABIAN OIL COMPANY, Dhahran (SA); REXONIC ULTRASONICS AG, Appenzell (CH); ARAMCO SERVICES COMPANY, Houston, TX (US)

(21) Appl. No.: 19/209,543

(22) Filed: May 15, 2025

(51) Int. Cl. E21B 37/00; E21B 47/00; G01N 15/00; G01N 15/06

(52) U.S. Cl. CPC E21B 37/00; E21B 47/00; G01N 15/06; G01N 2015/0053

(57) ABSTRACT

Acoustic systems and methods for enhanced cleaning of a wellbore are disclosed. The system may include at least one high-power acoustic emitter, configured to emit an acoustic field with a power spectrum into a fluid filling the wellbore; a sediment load meter, configured to measure a sediment load of the fluid; and a downhole computer processor, configured to modify the power spectrum based upon the measured sediment load.

### BACKGROUND

Hydrocarbon fluids are often found in hydrocarbon reservoirs located in porous rock formations below the surface of the Earth. Wells are drilled into the reservoirs, using drill bits attached to the lower end of a drill string, to access and produce the hydrocarbon fluids. Efficient well drilling requires the continuous removal of rock chips and other particulate matter (“drill cuttings”) from the vicinity of the drill bit and their return to the surface (“hole cleaning”). Failure to provide effective hole cleaning may lead to drilling issues, such as reduced rates-of-penetration, and drill strings becoming trapped or jammed in the wellbore (i.e., “stuck-pipe” incidents).

Conventionally, drill mud, pumped down an interior channel of the drill string and flowing through the annulus between the drill string and the wellbore wall, back to the surface, carrying the drill cutting with it, is the primary mechanism for hole cleaning. However, this conventional solution may often prove inadequate, particularly when drilling long highly-deviated or horizontal wellbores and/or when using under-balanced coiled-tubing drilling (UBCTD) methods.

### SUMMARY

This summary is provided to introduce a selection of concepts that are further described below in the detailed description. This summary is not intended to identify key or essential features of the claimed subject matter, nor it is intended to be used as an aid in limiting the scope of the claimed subject matter.

In general, in one aspect, embodiments relate to an acoustic system for enhanced cleaning of a wellbore are disclosed. The system may include at least one high-power acoustic emitter, configured to emit an acoustic field with a power spectrum into a fluid filling the wellbore; a sediment load meter, configured to measure a sediment load of the fluid; and a downhole computer processor, configured to modify the power spectrum based upon the measured sediment load.

In general, in one aspect, embodiments relate to a method for enhanced cleaning of a wellbore, including, disposing an acoustic system for enhanced cleaning, on a conveyance mechanism of a drilling system, conveying, using the conveyance mechanism, the acoustic system into a wellbore, and emitting, from at least one high-power acoustic emitter disposed on the acoustic system, an acoustic field with a power spectrum into a fluid filling the wellbore. The method may further include measuring, using a sediment load meter of the acoustic system, a sediment load of the fluid, and modifying, using a downhole computer processor, the power spectrum based at least in part, on the measured sediment load.

Other aspects and advantages of the invention will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 depicts a drilling system in accordance with one or more embodiments.

FIG. 2 depicts a drill string, bottomhole assembly and drill bit disposed in a wellbore in accordance with one or more embodiments disclosed herein.

FIG. 3A shows a system for enhanced cleaning of a wellbore, in accordance with one or more embodiments.

FIG. 3B depicts elements of a system for enhanced cleaning of a wellbore, in accordance with one or more embodiments.

FIGS. 4A-4C depict sediment load meters in accordance with one or more embodiments.

FIG. 5 depict a downhole turbine generator in accordance with one or more embodiments.

FIGS. 6A-6B depict schematic system elements in accordance with one or more embodiments.

FIG. 7 shows a flowchart in accordance with one or more embodiments.

FIG. 8 shows a schematic computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the disclosure, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements. In addition, throughout the disclosure, “or” is interpreted as “and/or,” unless stated otherwise.

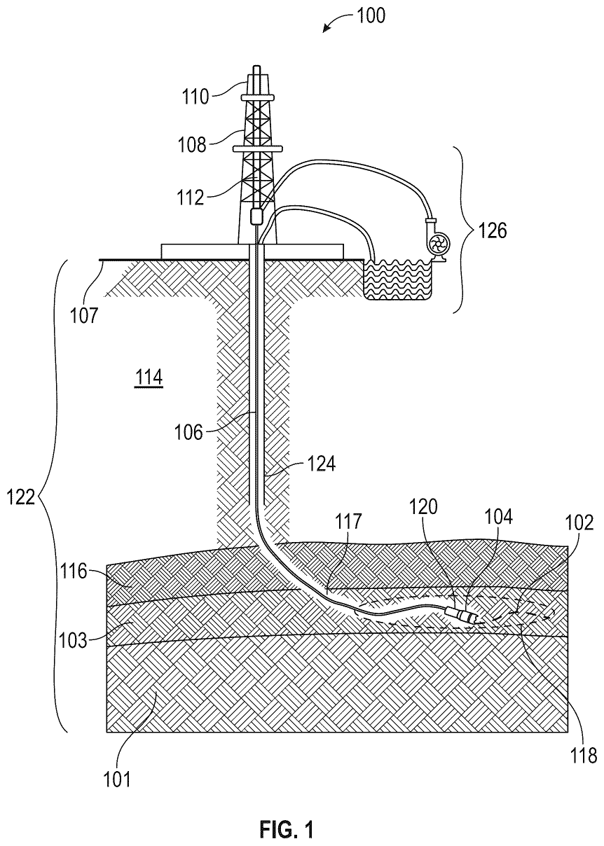

In the following description of FIGS. 1-7, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a sediment load meter” includes reference to one or more of such sediment load meters.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

When drilling a wellbore with a conventional drilling system the drill bit generates a continuous supply of rock fragments, known as drill cuttings, as the drill bit scrapes or cuts into the rock. Ideally, these drill cuttings become entrained in the drill mud circulation and are carried to the surface by the drill mud. However, in many cases, this ideal situation may not be fulfilled, and drill cuttings may accumulate at or near the drill bit, or at other locations along the wellbore. Such suboptimal hole cleaning may lead to reduced drilling efficiency and/or costly and unsafe stuck-pipe incidents. In such cases, a system to move the drill cuttings into suspension and entrain them in the circulating drill mud is desirable. The system disclosed herein for this purpose is an acoustic system that uses emitted acoustic waves to entrain, or fluidize, the drill cuttings. The system may further determine an optimal power spectrum, i.e., a suitable acoustic power intensity at each frequency within a frequency range for the emission of the acoustic waves to entrain the drill cuttings with an enhanced efficiency. In some embodiments, the optimal power spectrum may have a constant acoustic power intensity value of emitted acoustic power intensity over a frequency range, such as a range of ultrasonic frequencies, while in other embodiments, the optimal power spectrum may have varying value of emitted power over the range of frequencies. For example, the optimal power spectrum may have a maximum emitted power intensity value at a center frequency with decreasing values of emitted power over a range of frequencies above and below the center frequency.

As used herein, the term optimal power spectrum may mean the best of all possible power spectra, however it should also be interpreted to include the best of all power spectra tested, or scanned by the high-power acoustic system, even if there remains the possibility that there exists an even more effective power spectrum not tested or scanned by the high-power acoustic system. Similarly, in cases where each of a plurality of tested power spectra have essentially equivalent entraining or fluidizing effects the optimal power spectrum may be any one of these essentially equivalent spectra. Finally, in selecting an optimal power spectrum, factors other than the effectiveness or entraining or fluidizing sediment, such as drill cutting, may be considered. Hence for example, a power spectrum that is slightly less effective entraining or fluidizing sediment may be selected over a power spectrum that is slightly more effective as an optimum power spectrum if the slightly less effective power spectrum consumes significantly less power than the slightly more effective power spectrum.

The emitted acoustic waves may be emitted at ultrasonic frequencies, i.e., the emitted waves may be ultrasound waves and may be emitted with sufficiently high-power as to induce cavitation in the fluid filling the wellbore. Ultrasonic cavitation refers to the formation and collapse of cavities, or bubbles, in a liquid medium being subjected suddenly to low pressures. When a liquid is subjected to a high-intensity ultrasonic wave during the rarefaction part of the wave cycle, the pressure in the wave may fall below the ambient pressure, and gas bubbles may expand until the pockets collapse violently due to the high stresses developed in the walls of the bubble. Cavitation may have an important effect on many high-power ultrasonic applications in liquids, such as degassing or cleaning.

For better understanding the acoustic system, embodiments of typical environment in which it may operate is described below with reference to FIG. 1. FIG. 1 shows a drilling system (100) in accordance with one or more embodiments. Although the drilling system (100) shown in FIG. 1 is used to drill a wellbore on land, the drilling system (100) may also be a marine wellbore drilling system. The example of the drilling system (100) shown in FIG. 1 is not meant to limit the invention.

As shown in FIG. 1, a wellbore path (102) may be drilled by a drill bit (104) attached by a drill string (106) to a drill rig located on the surface (107) of the Earth. The drill rig may include framework, such as a derrick (108) to hold drilling machinery. The top drive (110) sits at the top of the derrick (108) and provides torque, typically a clockwise torque, via the drive shaft (112) to the drill string (106) in order to drill the wellbore. The wellbore may traverse a plurality of overburden (114) layers and one or more cap-rock (116) layers to a hydrocarbon reservoir (103) within the subterranean region of interest (101). The well is drilled to follow a wellbore path (102). The wellbore path (102) may be a curved wellbore path (directional well), or a straight wellbore path (vertical or horizontal well). All or part of the wellbore path (102) may be vertical, and some wellbore paths may be deviated or have horizontal sections.

Prior to the commencement of drilling, a wellbore plan may be generated. The wellbore plan may include a starting surface location of the wellbore, or a subsurface location within an existing wellbore, from which the wellbore may be drilled. Further, the wellbore plan may include a terminal location that may intersect with the target zone (118), e.g., a targeted hydrocarbon-bearing formation, and a planned wellbore path (102) from the starting location to the terminal location. In other words, the wellbore path (102) may intersect a previously located hydrocarbon reservoir (103).

The wellbore (117) may be drilled using a drill rig that may be situated on a land drill site, an offshore platform, such as a jack-up rig, a semi-submersible, or a drill ship. The drill rig may be equipped with a hoisting system, such as a derrick (108), which can raise or lower the drill string (106) and other tools required to drill the well. The drill string (106) may include one or more drill pipes connected to form conduit and a bottomhole assembly (“BHA”) (120) disposed at the distal end of the drill string (106). The BHA (120) may include a drill bit (104) to cut into subsurface (122) rock. The BHA (120) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit, the weight-on-bit, and the torque. The LWD measurements may include sensors, such as resistivity, gamma ray, and neutron density sensors, to characterize the rock formation surrounding the wellbore (117). Both MWD and LWD measurements may be transmitted to the surface (107) using any suitable telemetry system, such as mud-pulse or wired-drill pipe, known in the art.

To start drilling, or “spudding in” the well, the hoisting system lowers the drill string (106) suspended from the derrick (108) towards the planned surface location of the wellbore (117). An engine, such as a diesel engine, may be used to supply power to the top drive (110) to rotate the drill string (106). The weight of the drill string (106) combined with the rotational motion enables the drill bit (104) to bore the wellbore.

Casing (124) may be inserted in the well to support the wellbore and to prevent formation fluids entering the wellbore. The near-surface is typically made up of loose or soft sediment or rock, so large diameter casing (124), e.g., “base pipe” or “conductor casing,” is often put in place while drilling to stabilize and isolate the wellbore. At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface (107) of the earth.

Drilling may continue without any casing (124) once deeper, or more compact rock is reached. While drilling, a drill mud system (126) may pump drill mud from a mud tank on the surface (107) through an interior channel of the drill pipe, the center of the BHA (120), out through nozzles in the drill bit into the annulus between the drill string and the wellbore walls (or casing, where present) and back to the surface. Drill mud serves various purposes, including pressure equalization, drill bit cooling and lubrication and, removal of drilling cuts from around the drill bit and transporting them to the surface.

At planned depth intervals, drilling may be paused, and the drill string (106) withdrawn from the wellbore. Sections of casing (124) may be connected and inserted and cemented into the wellbore. Casing string may be cemented in place by pumping cement and mud, separated by a “cementing plug,” from the surface (107) through the drill pipe. The cementing plug and drill mud force the cement through the drill pipe and into the annular space between the casing and the wellbore wall. Once the cement cures, drilling may recommence. The drilling process is often performed in several stages. Therefore, the drilling and casing cycle may be repeated more than once, depending on the depth of the wellbore and the pressure on the wellbore walls from surrounding rock.

A drilling system (100) may be disposed at and communicate with other systems in the well environment. The drilling system (100) may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus.

As the wellbore becomes deeper, both successively smaller drill bits and casing string may be used. Drilling deviated or horizontal wellbores may require specialized drill bits or drill assemblies. Drilling may be considered complete when a target zone (118) is reached, or the presence of hydrocarbons is established.

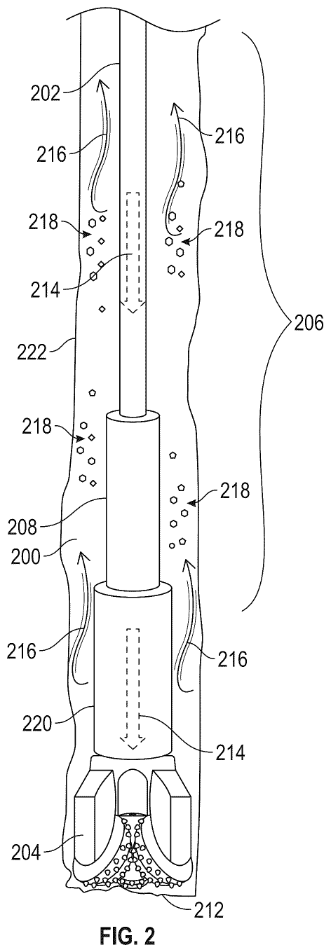

FIG. 2 depicts a drill string (206), BHA (220), and drill bit (204) disposed in a wellbore 200. The drill string (206) may be composed of drill pipe (202) and, in some cases, heavy-weight drill pipe (208), attached to the BHA (220). During drilling the drill pipe (202) is attached to the derrick (108) on the surface from which the drill pipe supports a portion of its own weight and that of the BHA (220) and drill bit (204). A further portion of the combined weight of the drill string (206), BHA (220) and the drill bit (204) is supported by the contact of the drill bit (204) with the rock forming the bottom of the wellbore (212). The drill bit (204) may be of any type known in the art, including roller-cone, or fixed-cutter bits, including milled-tooth, tungsten carbide insert, and polycrystalline diamond cutter bits, without departing from the scope of the invention.

The BHA (220) may include many different sensors and activators to facilitate the drilling process and characterize the rock through which the wellbore is being drilled. For example, sensors may measure weight-on-bit, torque, rotational speed (“RPM”), orientation (dip and azimuth), temperature, and fluid pressure. Similarly, sensors may measure the electrical resistivity, gamma ray emission, density, acoustic velocity, and porosity of the rock. The BHA (220) may also contain activators to push or point the drill bit (204) in a desired direction to facilitate steering the wellbore along an intended wellbore path. Further, the BHA (220) may include systems for communicating data and receiving instructions to and from the surface, e.g., using mud-pulse telemetry, and means for powering the sensors and activators contained within the BHA (220), such as a battery or downhole turbine generator.

Drill mud may be pumped from the surface down an interior channel of the drill pipe (202) and BHA (220) (see arrows (214)), out through nozzles in the drill bit (204) and back up the annulus between the drill pipe (202) and the wellbore wall (222) (see arrows (216)). In doing so, under ideal conditions, the drill mud may entrain drill cuttings (218) and carry the drill cuttings (218) back to the surface.

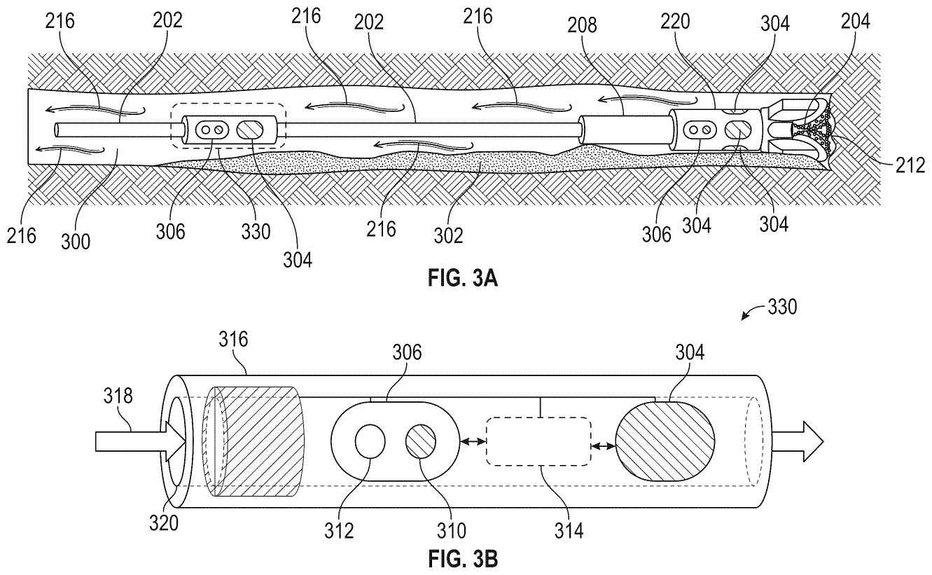

However, under many conditions, the drill mud may fail to remove all the drill cuttings in a complete and continuous manner, for example when drilling long highly-deviated or horizontal wellbores and/or when using under-balanced coiled-tubing drilling (UBCTD) methods. FIG. 3A illustrates one such example, where drill pipe (202), heavy-weight drill pipe (208), BHA (220) and drill bit (204) are shown drilling a horizontal wellbore (300). In these situations, drill cuttings may precipitate and form piles or “dunes” (302) along the bottom of the wellbore (300). These dunes (302) may remain static with respect to the wellbore (300) or may gradually migrate along the wellbore (300). In some instances, drill cuttings may accumulate near the drill bit (204) and the BHA (220), while in other instances, the drill cuttings may accumulate at other points in the wellbore (300) further from the bottom of the wellbore (212)

FIG. 3A also shows high-power acoustic systems in accordance with one or more embodiments. The high-power acoustic system may include one or more acoustic transducers (304) and the high-power acoustic system may be mounted on the BHA (220) or at intermediate locations along the drill pipe (202). The high-power acoustic emitters (304) may emit acoustic waves, over a power spectrum spanning a range of frequencies, into a fluid, such as the drilling mud, filling the wellbore (300) and induce a cavitation effect in the vicinity of the acoustic systems. In some embodiments, the frequencies of the emitted acoustic waves may be in the ultrasonic range, i.e., 18-25 kHz or higher, and the power intensity of the emitted acoustic waves may be high-power acoustic waves, e.g., 300 Watts or more. The parameters of the emitted acoustic waves are configured to cause the dune-forming drill cuttings (302) and other particulate matter to be fluidized and entrained in the drill mud (216) and carried with the drill mud (216) to the surface.

In some embodiments, the high-power ultrasonic waves may be configured to induce cavitation in the fluid filling the wellbore. When the ultrasonic intensity is strong enough, the original continuity of the liquid itself will be destroyed, and bubbles may be generated. Under these conditions, gas initially dissolved in the liquid will enter the bubbles. As time goes by, the bubbles will gradually increase. When the ultrasound pressure becomes positive pressure, the bubbles will shrink due to the tension on the bubble surface. However, as the surface area of the bubble shrinks, the volume of gas diffused into the liquid is reduced. When the next cycle of alternating positive and negative pressure comes, the volume of gas entering the bubble is always higher than that returning to the liquid. After multiple cycles, the volume of the bubble will become larger and larger, until a point is reached when the bubble cannot withstand the pressure of the internal gas and will rupture, thereby releasing energy. The effects of bubble growth, contraction, rupture and a series of physical disturbances produced by ultrasonic waves in liquid media are called cavitation effects.

The cavitation effect can be divided into stable cavitation and transient cavitation effect according to whether the cavitation bubble bursts or not. The bubbles in the stable cavitation effect will produce a series of acoustic effects when they propagate in the liquid medium. The micro-jet is one of them. The occurrence of a micro-jet is due to the violent circular motion of bubbles, which causes vortexes to be generated around the bubbles in the liquid medium. The violent disturbance generated by the stable cavity can improve the mass transfer and heat transfer efficiency, and the effect achieved may be greater than achieved by ordinary mechanical stirring.

In transient cavitation the ultrasonic cavitation bubble expands rapidly under high ultrasound pressure. When its volume reaches a critical point, the oscillating frequency of the bubble coincides with the ultrasonic frequency, and the bubbles will burst quickly during the compression stage, releasing large amounts of energy. The burst of a cavity bubble may generate instantaneous high temperature and high pressure around it.

The cavitation effect may play an important role in some application of ultrasound. Ultrasonic cavitation is a complex physical and chemical process. The formation and collapse of cavitation bubbles may depend on ultrasonic parameters, fluid viscosity, system flow rate, gas content, system temperature, and other conditions. Generally, not all cavitation bubbles can generate a significant cavitation effect for ultrasonic cavitation: the bubble nucleus may grow into a cavitation bubble, producing cavitation effect, only under selecting suitable conditions where the physical and chemical interactions and extreme physical environment of high temperature and high pressure occur in a small zone around the cavitation bubble. The ultrasonic parameters significantly affecting the cavitation effect may include ultrasonic frequency, intensity, and the design of the ultrasonic transducers.

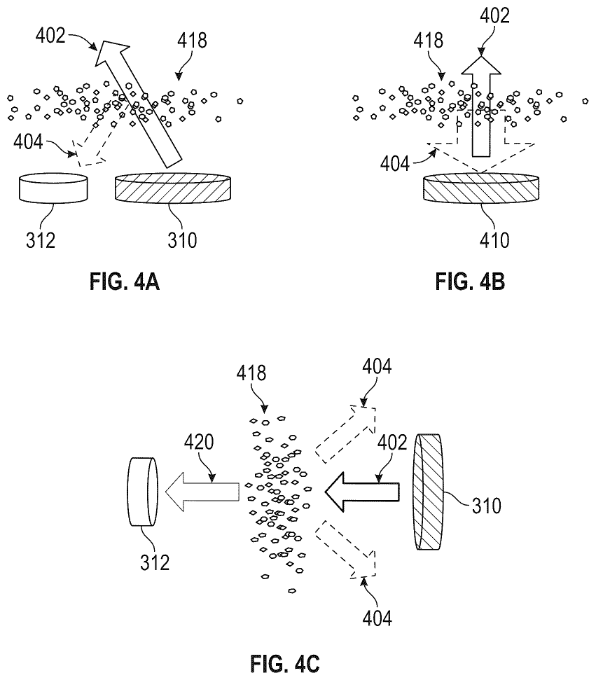

In some embodiments, the efficacy of the acoustic waves in entraining the drill cuttings (218) into the load of the flowing drill mud (216), may be monitored by one or more sediment load meters (306). Sediment load meters may include turbidity meters, that monitor the optical characteristics of the drilling, and/or may be acoustic sediment load meters (306). The functioning of an acoustic sediment load meter, such as sediment load meter (306) will be described below, in connection with FIGS. 4A-4C.

In some embodiments, the high-power acoustic emitter (304) may emit acoustic waves with a plurality of distinct frequencies. For example, the high-power acoustic emitter (304) may emit waves power spectrum between 15 kHz and 30 kHz power spectrum, without departing from the scope of the invention. Similarly, the high-power acoustic emitter (304) may emit acoustic waves with a plurality of distinct acoustic power intensity. For example, the high-power acoustic emitter (304) may emit waves between 300 Watts and 2000 Watts. For each combination set of these two parameters during the operations, a corresponding sediment load may be measured using the sediment load meter, and the corresponding measured sediment loads may be compared. An optimal power spectrum, i.e., a range of frequencies and power intensities selected based, at least in part, on the corresponding measured sediment load, may be determined. For example, the power spectrum that generates the largest sediment load suspended in the drilling mud or fluid may be selected as the optimal power spectrum. However, it may be necessary to consider other factors, such as power consumption, in the selection of the optimal power spectrum (304).

The optimal power spectrum of the emitted acoustic waves may be a power spectrum capable of entraining or fluidizing drill cuttings with a higher efficiency than other power spectra tested. In some embodiments, the optimal power spectrum may have a constant value of emitted acoustic power intensity over a frequency range, such as an ultrasonic frequency range, while in other embodiments, the optimal power spectrum may have varying values of emitted acoustic power intensity over the range of frequencies. For example, the optimal power spectrum may have a maximum emitted acoustic power intensity value at a center frequency and decreasing values of emitted acoustic power intensity over frequencies above and below the center frequency.

The combination of the optimal power spectrum, i.e., the range of frequencies and ultrasound power intensity may then be used by the high-power acoustic emitter to place the drill cutting into suspension, or to maintain the drill cuttings in suspension. In some embodiments, the high-power acoustic emitter may emit a continuous acoustic wave using the optimal power spectrum, while in other embodiments, the high-power acoustic emitter may emit a sequence of time-limited pulses using the optimal power spectrum.

Each of the steps described above: the emission of a sequence of pulses with varying frequency; the measurement of the corresponding sediment load of the drill mud; the selection of the optimal power spectrum and the ongoing excitation of the high-power acoustic emitter within the frequency range may be performed by, or under the control of, a downhole computer processor either autonomously, or with minimal control from surface operators. For example, in some embodiments, minimal control may include transmitting an initiation command to the downhole computer processor to begin the emission of the acoustic field and operate by controlling the acoustic power intensity accordingly to the measurements of the sediment load meter. In some embodiments, the high-power acoustic emitter and the sediment load meter may be powered from a direct power source at the surface, e.g., using a power cable of wireline, while in other embodiments, the high-power acoustic emitter and the sediment load meter may be powered from a downhole energy source. The energy source may be a battery, a downhole turbine generator, a downhole motion energy harvester, or any other energy source known in the art, alone or in combination, without departing from the scope of the invention.

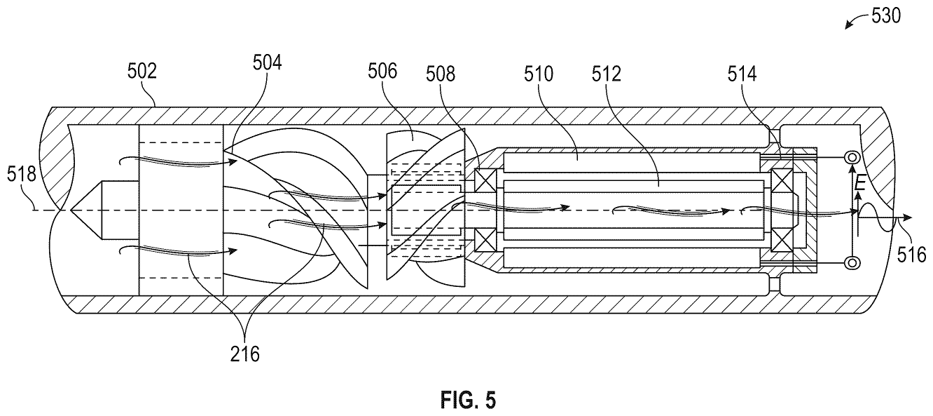

When mounted on the BHA (220) high-power acoustic emitters (304) and sediment load meter (306) may be configured to utilize the power sources and computer processors that may be a component of the BHA (220) systems. However, in embodiments when the acoustic system is disposed above the BHA (220) at an intermediate point on the drill pipe (202), such as the acoustic system (330), dedicated power source, and computer processors may be required. Such an embodiment is depicted in FIG. 3B. The acoustic system (330) depicted in FIG. 3B includes, in addition to the high-power acoustic emitter (304) and the sediment load meter (306), a computer processor (314) and an energy source (316). The energy source (316) may be connected to the high-power acoustic emitter (304), the sediment load meter (306), and the computer processor (314), and the computer processor may be communicatively connected to the high-power acoustic emitter (304) and/or the sediment load meter (306), to send control commands, for example which output power to emit, and to receive data, for example from the measured sediment load. In some embodiments, the energy source may be a downhole turbine generator as described in connection with FIG. 5.

The configuration of the sediment load meter may take a number of forms, three of which are depicted as illustrative examples in FIGS. 4A-4C. The type or design of sediment load meter should not be interpreted as limiting on the scope of the invention. In each depicted case, the measurement of sediment load is based upon the effect of the sediment load on an emitted acoustic wave. In FIG. 4A, an acoustic transmitter (310) is depicted emitting a beam or pulse of acoustic waves (402) into a fluid (i.e., sonification) containing a cloud of sediment (418) such as drill cuttings. The cloud of sediment (418) may reflect a portion of the emitted beam (402) to form a reflected wavefield (404) that may be detected by an acoustic receiver (312). One or both of the acoustic transmitter (310) and the acoustic receiver (312) may be a piezoelectric device. The magnitude or amplitude of the reflected wavefield (404) may be dependent on the characteristics of the sediment cloud (418), such that for a negligible density of sediment, i.e., a near-zero sediment load, the reflected amplitude may be near-zero, while for a large sediment load, the reflected amplitude may be correspondingly larger. In some variants of the embodiment shown in FIG. 4A, the acoustic transmitter (310) used by the sediment load meter may be one and the same as the high-power acoustic emitter (304), while in other embodiments, the acoustic transmitter (310) may be distinct from the high-power acoustic emitter (304) and dedicated to the task of measuring the sediment load.

In a second embodiment of the sediment load meter, shown in FIG. 4B, the functions of the acoustic transmitter (310) and the acoustic receiver (312) may be combined into a single transceiver (410) that both emits the beam (402) and detects the reflected acoustic wavefield (404).

A third embodiment of the sediment load meter is shown in FIG. 4C. In FIG. 4C the acoustic transmitter (310) may emit a beam or pulse of acoustic waves (402) (i.e., sonification) into a fluid containing a cloud of sediment (418), such as drill cuttings. The cloud of sediment (418) may reflect a portion of the emitted beam (402) to form a reflected wavefield (404) and may transmit the remainder of the emitted beam (402), forming a transmitted beam (420), that may be detected by an acoustic receiver (312). In the embodiment illustrated in FIG. 4C, a low value of sediment load will correspond to a large amplitude transmitted beam (420) while a high value of the sediment load will produce a small amplitude transmitted beam (420).

FIG. 5 shows a downhole turbine generator in accordance with one or more embodiments by way of illustration only. A downhole turbine generator is a hydraulic turbine machine designed to operate in oil and gas wells. It converts the energy of the flowing drill mud inside the drill-string into mechanical and then electrical energy to power downhole electrical equipment, such as the acoustic system. The outer diameter of the downhole turbine generator's casing is constrained by the internal dimensions of the tool housing (502), requiring the rotor structure to be designed as a slender rod, as shown in FIG. 5. The rotor-bearing system, i.e., the front bearings (508) and rear bearings (514), supports the rotor (512) and facilitates its rotation inside the stator (510). At least one of the stator and/or the rotor may include either electromagnets or permanent magnets, and the relative rotation of the rotor and stator may generate an electric current (516). The rotor (512) may be rigidly attached to impeller (506) and rotates with the impeller (506) when they are in turn caused to rotate by drill mud (216) flowing parallel to the central axis (518) of the downhole turbine generator (316).

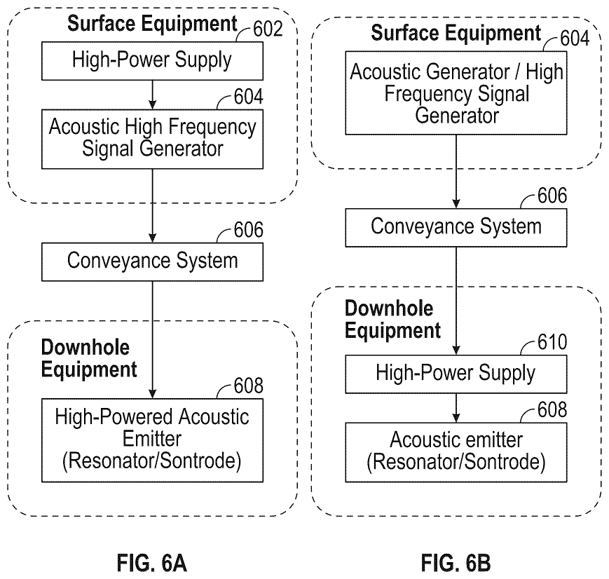

FIGS. 6A and 6B depict system elements in accordance with one or more embodiments. Specifically in FIG. 6A a surface high-power supply (602), e.g., an electric generator, or power grid connection may be connected to an acoustic or high-frequency signal generator (604). The surface system may further include a user interface system configured to monitor all measurements from the entire ultrasonic system and to control parameters such as frequency and output power. In some embodiments, the user interface may provide for manual operation, while in other embodiments much or all of the functions of the user interface may be automated.

A conveyance system (606), such as through wired coiled tubing or wired-drillpipe may transmit the high-frequency signal from the high-frequency signal generator (604) down the wellbore to the high-power acoustic emitter (608). Many designs of high-power acoustic emitter (608) are included within the scope of the invention, such as, without limitation, piezoelectric, resonator, and sonotrode designs. For example, a sonotrode may consist of a stack of piezoelectric transducers. An alternating current oscillating at ultrasonic frequencies, i.e., the high-frequency signal may be applied to the piezoelectric transducers. The current causes expansion and contraction of the piezoelectric transducers and the frequency of the current may be chosen to be the resonant frequency of the tool, so the entire sonotrode acts as a half-wavelength resonator vibrating lengthwise with standing waves at its resonant frequency. The frequencies used by the ultrasonic sonotrodes may typically be in a range from 15 kHz to 70 kHz, and the amplitude of the vibration may be small, e.g., 13 to 130 micrometres.

The high-power acoustic emitter (608) may be mounted on the BHA component of the drill system. The high-power acoustic emitter (608) may further contain one or more of the following elements or components that may work individually or together.

Transducers may form a core component of the high-power acoustic emitter (608). Transducers converts electrical energy into ultrasonic sound waves, and piezoelectric or magnetostrictive transducers may be used, without limitation. The transducer emits high-frequency high-power sound waves that propagate through the wellbore fluids and the surrounding formation. In general, these ultrasonic waves may break up blockages, remove scale, and increase the permeability of the formation, allowing oil to flow more freely.

Electrical transformers may be used to adjust and control the signal voltage supplied to the transducers. The electrical transformers convert the power from the high frequency signal generator to the appropriate voltage level required by the transducer. The electrical transformers ensure that the transducers receive the correct amount of electrical power to generate ultrasonic waves efficiently. Precise voltage control may be important to maintain the effectiveness and safety of the operation.

Converters may be responsible for changing the electrical power from direct current (DC) to alternating current (AC) or from one frequency to another. The converters modify the electrical input to the specific requirements of the transducer(s). By converting power to the necessary frequency and waveform, converters ensure that the transducers can generate the appropriate ultrasonic frequencies needed for fluidizing the drill cuttings and placing them into suspension.

One or more controllers may monitor and regulate the operation of the entire high-power acoustic emitter (608), including the power, frequency, and duration of the ultrasonic waves. Controllers allow fine-tuning of the ultrasound parameters, such as adjusting the intensity and duration of the stimulation. This is essential for optimizing the performance of the device in the specific conditions pertaining the wellbore environment at any time.

Boosters may amplify the ultrasonic waves generated by the transducer, increasing the intensity of the sound waves to ensure they have enough energy to fluidize the drill cuttings. The booster may be important for delivering high-power acoustic energy at ultrasonic frequencies to the desired depth in the wellbore. This amplification effect may help to fluidize the drill cuttings as well as dislodge blockages, reduce viscosity, and stimulate the flow of oil.

A coupling mechanism may be used to ensure the effective transmission of acoustic energy at ultrasonic frequencies from the transducer into the wellbore fluid and subsequently into the drill cuttings and the formation. Proper coupling is essential to minimize energy loss and ensure that the maximum amount of acoustic energy reaches the target area.

A power supply provides the electrical energy required to operate the high-power acoustic emitter (608). Such a power supply may convert a high-voltage AC from the grid to a lower voltage DC or AC power suitable for the electronics package of the high-power acoustic emitter. It is advantageous for the power supply to be stable and reliable to ensure continuous operation of the high-power acoustic emitter. In some cases, power supplies need to be ruggedized to withstand the harsh conditions of field operations.

The high-power acoustic emitter (608) may generate a significant amount of heat during operation and may require a dedicated cooling system. The cooling system may dissipate this heat to prevent damage to the transducers and other sensitive components. Efficient cooling may significantly improve the longevity and performance of the high-power acoustic emitter (608). The cooling systems may be of any appropriate heat dissipation technology known in the art.

A control interface may allow operators to interact with the high-power acoustic emitter, including inputting desired settings and monitoring the device's performance. The control interface may provide real-time feedback on the operation of the ultrasound system, allowing operators to make adjustments as necessary. The control interface may typically be located on the surface at the well-site or remotely connected to the system for ease of use. The control interface may monitor and control important operation parameters such as frequency, voltage, amperage, output power both in the surface generation device and in the subsurface device.

FIG. 6B shows an alternative embodiment of the high-power acoustic system where the high-frequency signal is transmitted from the high-frequency acoustic generator (604) down the wellbore using the conveyance mechanism (606) to be amplified in power by a downhole high-power supply (610) prior to driving the high-power acoustic emitter (608). In such embodiments, the high-power supply (610) may be provided by batteries, mud turbines, or through wired drill pipes or coiled tubing from the surface, individually or in combination. For embodiments involving disposing the high-power acoustic emitter (608) on the BHA the high power supply may be provided from existing high-power supplies integrated into the BHA.

The high-power acoustic system, shown in FIG. 6B may also have an interface system (not shown) that may be disposed on the surface or, in whole or in part, downhole to monitor and control important operation parameters such as frequency, voltage, amperage, output power.

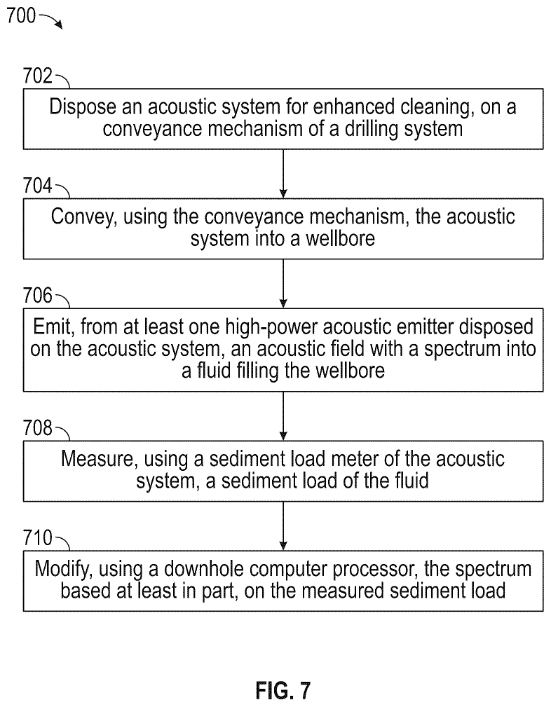

FIG. 7 shows a flowchart (700) pertaining to one or more embodiments. In Step (702) an acoustic system for enhanced cleaning, may be attached to a conveyance mechanism of a drilling system. In some optional embodiments, the conveyance may be a drill string composed of a plurality of drill pipe segments, while in other optional embodiments, the drill string may be a coiled tubing system. The acoustic system may optionally form part of the BHA (220) or may optionally be positioned above the BHA (220) at an intermediate point along the drill string.

In Step (704), the acoustic system may be conveyed into a wellbore using the conveyance mechanism. The acoustic system may be conveyed into the wellbore as part of the drilling processes whereby the drilling systems deepens or extends the length of the wellbore.

In Step (706), each of the at least one high-power acoustic emitter disposed on the acoustic system may emit an acoustic field within a certain frequency range into a fluid, such as drill mud, filling the wellbore. Emitting the acoustic field may include initiating activation of the at least one high-power acoustic emitter, via a command from a command-and-control system, disposed on a surface of the Earth, and in communication with the downhole computer processor.

In Step (708), a sediment load of the fluid may be measured, using a sediment load meter of the acoustic system, where the sediment load may be primarily or wholly composed of drill cuttings. In some embodiments, the sediment load meter may be a turbidity sensor, while in other embodiments, the sediment load meter may be an acoustic sediment load meter.

In Step (710), various parameters may be modified manually or automatically depending on the modes, using a downhole computer processor, based at least in part, on the measured sediment load. For example, the power spectrum, i.e., the combination of power intensity and frequency that maximizes the measured sediment load may be selected as the optimal power spectrum, although other factors such as the energy required power spectrum may be considered as well. In some embodiments, other parameters, such as voltage, amperage, frequency, and power output may be monitored and used in determining the optimal power spectrum, i.e., in determining the optimal combination of operating parameters.

Typically, the optimal power spectrum or range of frequencies may be an optimal ultrasonic power spectrum and be configured to promote suspension of sediment, such as drill cuttings, in the fluid, i.e., drill mud. However, in some embodiments, the optimal power spectrum may include frequencies above or below the ultrasonic range.

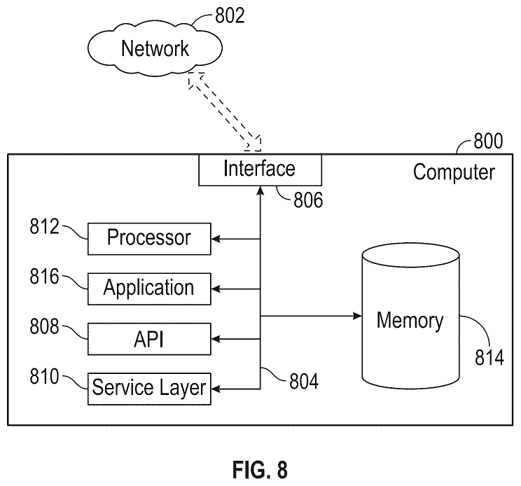

In some embodiments the command-and-control system on the surface of the Earth and the downhole computer processor may each include a computer system, such as the computer system shown in FIG. 8. FIG. 8 shows a block diagram of a computer system (800) used to provide computational functionalities associated with described algorithms, methods, functions, processes, flows, and procedures as described in the instant disclosure, according to an implementation. The illustrated computer system (800) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer system (800) may include a computer that includes an input device, such as a keypad, keyboard, touch screen, or other device that can accept user information, and an output device that conveys information associated with the operation of the computer system (800), including digital data, visual, or audio information (or a combination of information), or a GUI.

The computer system (800) can serve in a role as a client, network component, a server, a database or other persistency, or any other component (or a combination of roles) of a computer system for performing the subject matter described in the instant disclosure. The illustrated computer system (800) is communicably coupled with a network (802). In some implementations, one or more components of the computer system (800) may be configured to operate within environments, including cloud-computing-based, local, global, or other environment (or a combination of environments).

At a high level, the computer system (800) is an electronic computing device operable to receive, transmit, process, store, or manage data and information associated with the described subject matter. According to some implementations, the computer system (800) may also include or be communicably coupled with an application server, e-mail server, web server, caching server, streaming data server, business intelligence (BI) server, or other server (or a combination of servers).

The computer system (800) can receive requests over network (802) from a client application (for example, executing on another computer system (800)) and responding to the received requests by processing the said requests in an appropriate software application. In addition, requests may also be sent to the computer system (800) from internal users (for example, from a command console or by other appropriate access method), external or third-parties, other automated applications, as well as any other appropriate entities, individuals, systems, or computers.

Each of the components of the computer system (800) can communicate using a system bus (804). In some implementations, any or all of the components of the computer system (800), both hardware or software (or a combination of hardware and software), may interface with each other or the interface (806) (or a combination of both) over the system bus (804) using an application programming interface (API) (808) or a service layer (810) (or a combination of the API (808) and service layer (810). The API (808) may include specifications for routines, data structures, and object classes. The API (808) may be either computer-language independent or dependent and refer to a complete interface, a single function, or even a set of APIs. The service layer (810) provides software services to the computer system (800) or other components (whether or not illustrated) that are communicably coupled to the computer (800). The functionality of the computer (800) may be accessible for all service consumers using this service layer. Software services, such as those provided by the service layer (810), provide reusable, defined business functionalities through a defined interface. For example, the interface may be software written in JAVA, C++, or other suitable language providing data in extensible markup language (XML) format or other suitable format. While illustrated as an integrated component of the computer (800), alternative implementations may illustrate the API (808) or the service layer (810) as stand-alone components in relation to other components of the computer (800) or other components (whether or not illustrated) that are communicably coupled to the computer (800). Moreover, any or all parts of the API (808) or the service layer (810) may be implemented as child or sub-modules of another software module, enterprise application, or hardware module without departing from the scope of this disclosure.

The computer (800) includes an interface (806). Although illustrated as a single interface (806) in FIG. 8, two or more interfaces (806) may be used according to particular needs, desires, or particular implementations of the computer (800). The interface (806) is used by the computer (800) for communicating with other systems in a distributed environment that are connected to the network (802). Generally, the interface (806) includes logic encoded in software or hardware (or a combination of software and hardware) and operable to communicate with the network (802). More specifically, the interface (806) may include software supporting one or more communication protocols associated with communications such that the network (802) or interface's hardware is operable to communicate physical signals within and outside of the illustrated computer (800).

The computer (800) includes at least one computer processor (812). Although illustrated as a single computer processor (812) in FIG. 8, two or more processors may be used according to particular needs, desires, or particular implementations of the computer (800). Generally, the computer processor (812) executes instructions and manipulates data to perform the operations of the computer (800) and any algorithms, methods, functions, processes, flows, and procedures as described in the instant disclosure.

The computer (800) also includes a memory (814) that holds data for the computer (800) or other components (or a combination of both) that may be connected to the network (802). For example, memory (814) may be a database storing data consistent with this disclosure. Although illustrated as a single memory (814) in FIG. 8, two or more memories may be used according to particular needs, desires, or particular implementations of the computer (800) and the described functionality. While memory (814) is illustrated as an integral component of the computer (800), in alternative implementations, memory (814) may be external to the computer (800).

In addition to holding data, the memory may be a non-transitory medium storing computer readable instruction capable of execution by the computer processor (812) and having the functionality for carrying out manipulation of the data including mathematical computations.

The application (816) is an algorithmic software engine providing functionality according to particular needs, desires, or particular implementations of the computer (800), particularly with respect to functionality described in this disclosure. For example, application (816) can serve as one or more components, modules, applications, etc. Further, although illustrated as a single application (816), the application (816) may be implemented as multiple applications (816) on the computer (800). In addition, although illustrated as integral to the computer (800), in alternative implementations, the application (816) may be external to the computer (800).

There may be any number of computers (800) associated with, or external to, a computer system containing computer (800), each computer (800) communicating over network (802). Further, the term “client,” “user,” and other appropriate terminology may be used interchangeably as appropriate without departing from the scope of this disclosure. Moreover, this disclosure contemplates that many users may use one computer (800), or that one user may use multiple computers (800).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. An acoustic system for enhanced cleaning of a wellbore, comprising:
at least one acoustic emitter attached to a drill string, and configured to entrain drill cuttings by emitting an acoustic field with a power spectrum into a fluid filling the wellbore during the drilling of the wellbore with the drill string, wherein the power spectrum comprises a power of at least 300 Watts;
a sediment load meter attached to a drill string, configured to measure a sediment load of the fluid, wherein the sediment comprises drill cuttings; and
a downhole computer processor, attached to the drill string, configured to modify the power spectrum, used to entrain drill cuttings, based upon the measured sediment load.

2. The acoustic system of claim 1, wherein the at least one acoustic emitter is disposed on the drill string above a bottomhole assembly.

3. The acoustic system of claim 1, wherein the sediment load meter comprises an acoustic sediment load meter.

4. The acoustic system of claim 3, wherein the acoustic sediment load meter is configured to record acoustic energy scattered from the acoustic field emitted by at least one acoustic transmitter.

5. The acoustic system of claim 1, wherein the sediment load meter comprises a turbidity meter.

6. The acoustic system of claim 1, further comprising a downhole turbine generator configured to supply electrical energy to the at least one acoustic emitter.

7. (canceled)

8. The acoustic system of claim 1, wherein the power spectrum of the acoustic emitter comprises an ultrasonic power spectrum.

9. The acoustic system of claim 1, wherein the downhole computer processor is further configured to:
cause the at least one acoustic emitter to emit a plurality of distinct power spectra;
for each distinct power spectrum within the plurality of distinct power spectra, using the sediment load meter, measure a corresponding sediment load; and
select the power spectrum based on the distinct power spectrum, within the plurality of distinct power spectra, that generates a largest measured sediment load.

10. The acoustic system of claim 1, wherein the acoustic field is configured to promote suspension of drill cuttings in the fluid.

11. The acoustic system of claim 1, wherein the at least one acoustic emitter is configured to generate acoustic waves with an amplitude large enough to induce cavitation in the fluid filling the wellbore.

12. The acoustic system of claim 1, further comprising a command-and-control system, disposed on a surface of the Earth and in communication with the downhole computer processor, configured to initiate activation of the at least one acoustic emitter.

13. A method for enhanced cleaning of a wellbore, comprising:
disposing an acoustic system for enhanced cleaning, on a drill string of a drilling system;
conveying, using the drill string, the acoustic system into a wellbore;
entraining drill cuttings by emitting, from at least one acoustic emitter disposed on the acoustic system, an acoustic field with a power spectrum into a fluid filling the wellbore,
wherein the power spectrum comprises a power of at least 300 Watts;
measuring, using a sediment load meter of the acoustic system for enhanced cleaning, a sediment load of the fluid,
wherein the sediment comprises drill cuttings; and
modifying, using a downhole computer processor attached to the drill string, the power spectrum used to entrain drill cuttings based, at least in part, on the measured sediment load.

14. The method of claim 13, wherein emitting an acoustic field comprises initiating activation of at least one acoustic emitter, via a command from a command-and-control system, disposed on a surface of the Earth, and in communication with the downhole computer processor.

15. The method of claim 13, wherein modifying the power spectrum comprises:
emitting, using the at least one acoustic emitter, plurality of distinct power spectra;
measuring, for each distinct power spectrum of the plurality of distinct power spectra, using the sediment load meter, a corresponding sediment load; and
selecting a power spectrum based on the distinct power spectrum within the plurality of distinct power spectra that generates a largest measured sediment load.

16. The method of claim 13, wherein the acoustic system is disposed on the drill string above a bottomhole assembly.

17. The method of claim 13, wherein the emitted acoustic field is configured to generate acoustic waves with an amplitude large enough to induce cavitation in the fluid filling the wellbore.

18. The method of claim 13, wherein the acoustic field is configured to promote suspension of sediment in the fluid.

19. (canceled)

20. The method of claim 13, wherein the sediment load meter comprises an acoustic sediment load meter.
